(19) United States
(12) Patent Application Publication
(10) Pub. No.: US 2019/0340576 A1
(43) Pub. Date: Nov. 7, 2019

(54) Methods and Systems for Multiple to Single Entity Matching

(71) Applicant: Capital One Services, LLC, McLean, VA (US)

(72) Inventors: Austin Walters, Savoy, IL (US); Alvin Hua, Emeryville, CA (US); Vincent Pham, Champaign, IL (US)

(73) Assignee: Capital One Services, LLC, McLean, VA (US)

(21) Appl. No.: 15/967,646

(22) Filed: May 1, 2018

(51) Int. Cl. G06Q 10/10; G06F 17/30

(52) U.S. Cl. CPC G06Q 10/1053; G06F 17/30867; G06F 17/3053

(57) ABSTRACT

Embodiments disclosed herein generally relate to a system and method for generating an ideal job candidate description. A computing system identifies a group of users. The group of users includes at least a first user. The computing system transmits a series of profiles for display on a respective client device of each user to prompt the user to either like or dislike each profile. For each profile that is liked and disliked, the computing system identifies one or more traits of the candidate represented by the profile. The computing system generates a preferred candidate profile for each user based on the identified one or more traits. The computing system aggregates the one or more traits liked by all users and the one or more traits disliked by all users. The computing system generates an ideal candidate description based on the aggregated one or more traits.

### FIELD OF THE DISCLOSURE

The present disclosure generally relates to a method and a system for generating an ideal job candidate description and, subsequently, selecting a candidate from a pool of candidates.

### BACKGROUND

Today's companies face a challenge of efficiently finding suitable candidates that fit the requirements set forth by job openings that are available. Such a process becomes more difficult as hiring committees at these companies increase in number, due to the conflicting nature of what each member of the hiring committee values in a quality hire. As a result, the hiring process for a particular job opening may be time consuming and, in some situations, the company may end up selecting a candidate that does not accurately fit the needs set forth in the job opening.

### SUMMARY

Embodiments disclosed herein generally relate to a system and method for generating a job candidate description and, subsequently selecting a candidate from a pool of candidates. A computing system identifies a group of users. The group of users includes at least a first user. For each user of the group of users, the computing system transmits a series of profiles for display on a respective client device of each user to prompt the user to either like or dislike each profile. Each profile in the series of profiles represents a candidate. For each profile that is disliked, the computing system identifies one or more traits of the candidate represented by the profile. For each profile that is liked, the computing system identifies one or more traits of the candidate represented by the profile. The computing system generates a preferred candidate profile for each user based on the identified one or more traits that have been liked and the one or more traits that have been disliked. The computing system aggregates the one or more traits liked by all users of the group of users and the one or more traits disliked by all users of the group of users. The computing system generates an ideal candidate description based on the aggregated one or more traits.

In some embodiments, the computing system further receives a plurality of candidate profiles. The computing system compares each of the plurality of candidate profiles to the ideal candidate description.

In some embodiments, the computing system scores each of the plurality of candidate profiles based on the ideal candidate description.

In some embodiments, the computing system transmits each of the plurality of candidate profiles to the respective client device of each user in an order ranging from a highest scoring candidate profile to a lowest scoring candidate profile.

In some embodiments, the computing system scores each of the plurality of candidates based on the preferred candidate profile of each user.

In some embodiments, the computing system transmits each of the plurality of candidate profiles to the first client device of the first user in an order ranging from a highest scoring candidate profile to a lowest scoring candidate profile, based on a first preferred candidate profile associated with a first user.

In some embodiments, generating a preferred candidate profile for each user based on the identified one or more elements that have been liked and the one or more elements that have been disliked includes the computing system analyzing each profile liked and disliked by the first user. The computing system identifies a pattern of behavior of profile liking that is indicative of a bias. The computing system adjusts the preferred candidate profile for the first user based on the bias.

In some embodiments, identifying one or more traits of the candidate represented by the profile includes the computing system scanning the profile. The computing system extracts the one or more traits from the profile.

In another embodiment, a method is disclosed herein. A computing system identifies a group of users. The group includes at least a first user. The computing system receives a series of profiles. Each profile in the series of profiles represents a candidate. The computing system divides each of the profiles into one or more segments. Each segment corresponds to a particular trait of the candidate represented by the profile. For each user of the group of users, the computing system transmits a series of profiles for display on a respective client device of each user to prompt the user to either like or dislike one or more traits in each profile. The computing system identifies one or more traits liked by each user across the series of profiles. The computing system identifies one or more traits disliked by each user across the series of profiles. The computing system generates a preferred candidate profile for each user based on the identified one or more traits that have been liked and the one or more traits that have been disliked. The computing system aggregates the one or more traits liked by the users and the one or more traits disliked by the user. The computing system generates an ideal candidate description based on the aggregated one or more traits.

In some embodiments, the computing system receives a plurality of candidate profiles. The computing system compares each of the plurality of candidate profiles to the ideal candidate description.

In some embodiments, the computing system scores each of the plurality of candidate profiles based on the ideal candidate description.

In some embodiments, the computing system transmits each of the plurality of candidate profiles to the respective client device of each user in an order ranging from a highest scoring candidate profile to a lowest scoring candidate profile.

In some embodiments, the computing system scores each of the plurality of candidate profiles based on the preferred candidate profile of each user.

In some embodiments, the computing system transmits each of the plurality of candidate profiles to the first client device of the first user in an order ranging from a highest scoring candidate profile to a lowest scoring candidate profile based on a first preferred candidate profile associated with the user.

In some embodiments, generating preferred candidate profile for each user based on the identified one or more elements that have been liked and the one or more elements that have been disliked includes the computing system analyzing each profiled liked and disliked by the first user. The computing system identifies a behavior of profile liking that is indicative of a bias. The computing system adjusts the preferred candidate profile for the first user based on the bias.

In some embodiments, identifying one or more traits of the candidate represented by the profile includes the computing system scanning the profile. The computing system extracts the one or more traits from the profile.

In another embodiment, a method is disclosed herein. A computing system receives a series of profiles for display. Each profile in the series of profiles represents a candidate. The computing system generates a graphical user interface (GUI) for display on a client device of the user for each of the series of profiles. The computing system identifies segmentation information associated with each of the series of profiles. Each set of segmentation information comprises boundary information for one or more portions of each profile. Each of the one or more portions corresponds to a trait in the profile. The computing system generates one or more touch sensitive locations in the GUI based on the segmentation information. The computing system identifies a region of the GUI selected by the user. The computing system transmits the selection information to a central server.

In another embodiment, identifying a region of the GUI selected by the user includes the computing system identifying a button selected by the user in the region displayed on the client device.

In another embodiment, the button is one of a like button and a dislike button.

In another embodiment, identifying a region of the GUI selected by the user includes the computing system identifying a direction in which the user dragged a finger across the region of the GUI.

In another embodiment, identifying a region of the GUI selected by the user includes identifying at least two regions of the GUI selected by the user.

In another embodiment, the computing system receives a plurality of candidate profiles based on selection information transmitted to the central server. The computing system generates a second GUI to display a first candidate profile to the user.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating an exemplary computing environment, according to one embodiment.

FIG. 2 is an exemplary block diagram illustrating components of the computing environment of FIG. 1 in more detail, according to one embodiment.

FIG. 3 is a flow diagram illustrating an exemplary method of generating an ideal candidate description, according to one embodiment.

FIG. 4 is a flow diagram illustrating an exemplary method of generating an ideal candidate description, according to one embodiment.

FIG. 5 is a block diagram illustrating an exemplary method of identifying a selection of a user, according to one embodiment.

FIG. 6 is a block diagram illustrating an exemplary graphical user interface (GUI) displayed on a client device, according to one embodiment.

FIG. 7 is a block diagram illustrating an exemplary GUI displayed on a client device, according to one embodiment.

FIG. 8 is a block diagram illustrating an exemplary computing environment, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure generally relates to a method and system for generating an ideal candidate description. In particular, the present disclosure is directed to a method and system for generating an ideal job candidate description based on aggregated feedback from a group of users. In some embodiments, the aggregated feedback may be generated by presenting each user of the group of users a series of stock candidate profiles. Each user may provide feedback in the form of a “like” or “dislike” of the profile. The one or more techniques disclosed herein analyze the feedback received from the group of users, and identifies one or more commonalities among the group of users to generate an ideal candidate description.

In some embodiments, the present disclosure relates to generate an ideal candidate job description for a particular opening at a place of business. For example, to generate the ideal candidate job description, one or more techniques disclosed herein present to a group of users (e.g., a hiring committee at the place of business) a series of stock profiles (or resumes) for which each user in the group of users will provide feedback. For example, one or more techniques disclosed herein may present to the user a profile of a candidate, in which the user may either provide a like or dislike input. In some embodiments, the like or dislike input may be in the form of a button on the screen of the user's client device. In some embodiments, the like or dislike input may be in the form of a swipe touch command across the screen of the user's client device (e.g., swipe left for dislike, swipe right for like).

For each user in the group of users, the system may analyze a cluster (or set) of stock profiles for which the user provided input to identify one or more preferences of the user. For example, the system may identify that the user is particular to a certain job skill, work experience, and the like, while not being particular to a grade point average or place of education. Using this information, the system may identify an ideal candidate description for each user on an individual basis.

Further, in some embodiments, the system may aggregate the preferences of each user in the group of users to generate an ideal candidate description on a group level. For example, one or more techniques disclosed herein may identify common features among the individual preferences to generate an ideal candidate description on a group basis.

Once the ideal candidate description is generated, in some embodiments, the system may present to each user a series of candidate profiles for the job opening. In some embodiments, the system may present to each user those candidate profiles that the user is more likely to approve than disapprove. For example, the system may score each candidate profile by comparing each candidate profile to the user's individual preferences, and present to the user those candidate profiles the user is more likely to approve. By identifying what each user is looking for, and building a profile of what each user values, the system can more efficiently present profiles to each user, thereby improving the efficiency of the hiring process.

The term “user” as used herein includes, for example, a person or entity that owns a computing device or wireless device; a person or entity that operates or utilizes a computing device; or a person or entity that is otherwise associated with a computing device or wireless device. It is contemplated that the term “user” is not intended to be limiting and may include various examples beyond those described.

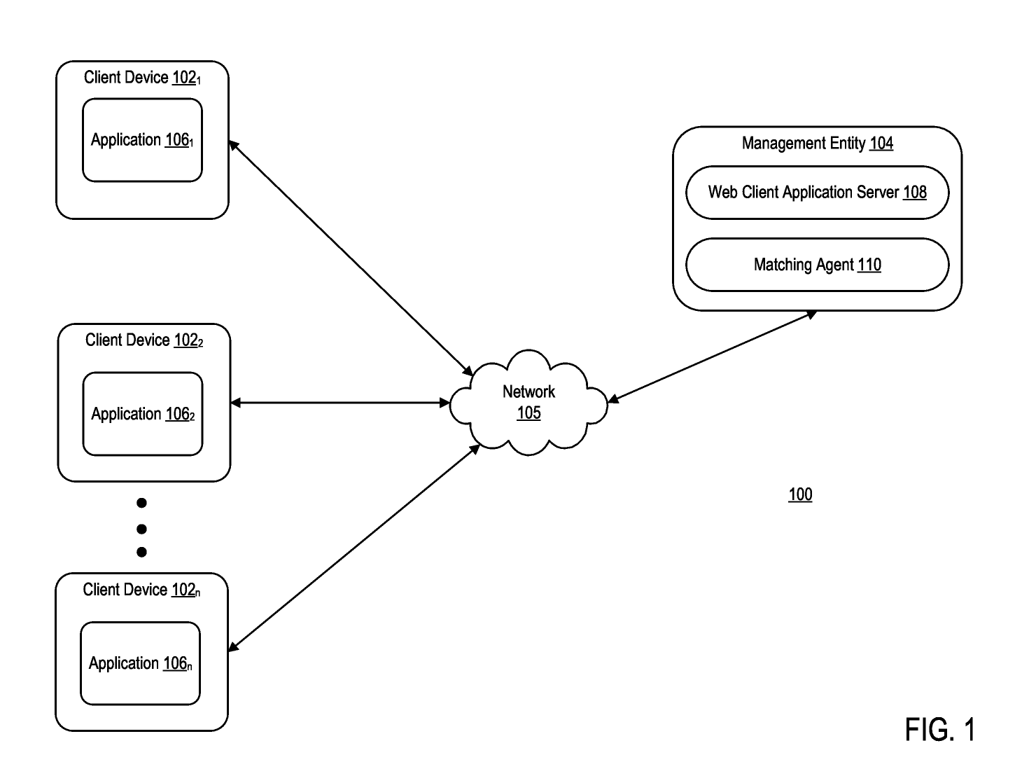

FIG. 1 is a block diagram illustrating a computing environment 100, according to one embodiment. Computing environment 100 may include one or more client devices 102₁, 102₂, and 102ₙ (generally “client device 102”) and management entity 104 communicating via network 105. Client device 102 may be operated by one or more users. For example, client device 102 may be a mobile device, a tablet, a desktop computer, or any computing system having the capabilities described herein.

Client device 102 may include at least an application 106. Illustratively, client device 102₁ may include application 106₁, client device 102₂ may include application 106₂, and client device 102ₙ may include application 106ₙ. Application 106 may be representative of a web browser that allows access to a website or a stand-alone application. User 101 may access application 106 to access functionality of management entity 104. User 101 operating client device 102 may communicate over network 105 to request a webpage, for example, from web client application server. For example, client device 102 may be configured to execute application 118 to access content managed by web client application server 108. The content that is displayed to user 101 may be transmitted from web client application server 108 to client device 102, and subsequently processed by application 106 for display through a graphical user interface (GUI) of client device 102.

Management entity 104 may further include matching agent 110. Management entity 104 may be comprised of one or more software modules. The one or more software modules are collections of code or instructions stored on a media (e.g., memory of management entity 104) that represent a series of machine instructions (e.g., program code) that implements one or more algorithmic steps. Such machine instructions may be the actual computer code the processor of management entity 104 interprets to implement the instructions, or, alternatively, may be a higher level coding of the instructions that is interpreted to obtain the actual computer code. The one or more software modules may also include one or more hardware components. One or more aspects of an example algorithm may be performed by the hardware components (e.g., circuitry) itself, rather as a result of an instruction.

Matching agent 110 may be configured to interact with user of client device 102 via application 106 to generate an ideal description of a candidate. In operation, application 106 executing on client device 102 may present to user a plurality of profiles to be displayed to the user. For example, application 106 may present to user a plurality of job resumes for a job opening at user's place of employment. Via application 106, user of client device 102 may either like or dislike each profile. In some examples, liking or disliking a profile may correspond to whether an applicant represented by the job resume is qualified for the job opening. Matching agent 110 may aggregate likes or dislikes from a plurality of users (e.g., a plurality of employees at the place of employment) to generate an ideal candidate description. For example, matching agent 110 may identify common traits among those profiles that are liked and disliked, and subsequently generate requirements for the job based on these identified traits.

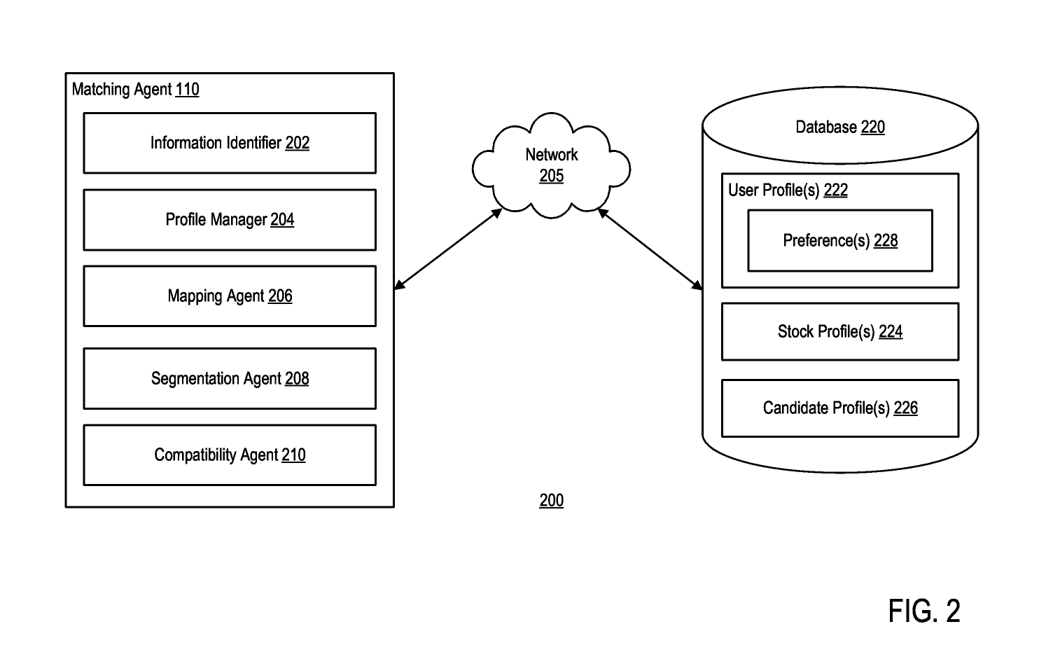

FIG. 2 is a block diagram 200 illustrating computing environment 100 in more detail, according to one embodiment. As illustrated, matching agent 110 is in communication with database 220 via network 205.

Matching agent 110 may include an information identifier 202, a compatibility agent 204, a profile manager 206, a mapping agent 208, and a segmentation agent 210. Each of information identifier 202, compatibility agent 204, profile manager 206, mapping agent 208, and segmentation agent 210 may be comprised of one or more software modules. The one or more software modules are collections of code or instructions stored on a media (e.g., memory of management entity 104) that represent a series of machine instructions (e.g., program code) that implements one or more algorithmic steps. Such machine instructions may be the actual computer code the processor of management entity 104 interprets to implement the instructions, or, alternatively, may be a higher level coding of the instructions that is interpreted to obtain the actual computer code. The one or more software modules may also include one or more hardware components. One or more aspects of an example algorithm may be performed by the hardware components (e.g., circuitry) itself, rather as a result of an instruction.

Information identifier 202 may be configured to analyze each profile acted upon (i.e., either liked or disliked) by the user. For example, in operation, matching agent 110 may display to user of client device 102 a stock profile (e.g., from stock profiles 224 in database 220) for display. Upon receiving an indication from the user of either a like or a dislike, information identifier 202 may parse the profile to identify one or more characteristics of the profile. Initially, information identifier 202 may analyze each profile acted upon by the user in one or more clusters. For example, rather than initially analyzing each profile acted upon by the user without any context, information identifier 202 may analyze a cluster of profiles (e.g., 10 profiles) to identify common traits among those profiles that were liked and among those profiles that were disliked. Once information identifier 202 has determined a baseline of traits a particular user either likes or dislikes, information identifier 202 may more easily analyze subsequent profiles acted upon on an individual basis.

In some embodiments, information identifier 202 may store the one or more traits either liked or disliked by the particular user in database 202. As illustrated, database 202 may include user profiles 222, stock resumes 224, and candidate resumes 226. Each user profile 222 may correspond to a respective user. For example, each user profile 222 may correspond to a particular employee in a hiring committee of a place of business. Each profile 222 may include preferences 228. Preferences 228 may correspond to the one or more traits identified by information identifier 202. Preferences 228 may include one or more traits a user likes, one or more traits a user dislikes, one or more categories of traits the user focuses on, and the like. For example, preferences 228 may include a minimum grade point average (GPA), a particular undergraduate institution, a particular work history (e.g., clerkship), a particular category of information (e.g., publication information), and the like.

Stock profiles 224 may include one or more profiles to be displayed to the users. One or more profiles in stock profiles 224 may be displayed to a particular user in the process of generating an ideal description of a candidate. For example, stock profiles 224 may include one or more stock resumes submitted to the place of business. In another example, stock profiles 224 may include one or more stock resumes unrelated to the place of business. Matching agent 110 may present one or more stock profiles 224 to user to determine user's preferences of an ideal candidate for a particular job opening.

Profile manager 204 may manage one or more user profiles 222. Profile manager 204 may be configured, for example, to identify one or more biases associated with each user. In operation, profile manager 204 may analyze preferences associated with a particular user profile 222 to identify whether user associated with user account 222 is biased towards a particular trait. In some embodiments, profile manager 204 may identify, for example, a positive bias so that more likely approved candidate will shuffle up. For example, profile manager 204 may analyze preferences 228 of user profile 222 and determine that the particular user is biased towards candidates from a particular university (e.g., the university that the user attended). In some embodiments, profile manager 204 may identify a negative bias and remove it from the likelihood matching. Accordingly, profile manager 204 may adjust preferences 228 by applying one or more weights to each preference. Continuing with the prior example, profile manager 204 may apply a weight to the category of “undergraduate institution” to lessen the influence of that category for the ideal candidate description.

Mapping agent 206 may be configured to aggregate preferences 228 across all user profiles 222. Mapping agent 206 may identify one or more preferences common among preferences 228 of all user profiles 222. For example, mapping agent 206 may identify that proficiency in C++ programming language is a common preference among at least a majority of user profiles 222. In another example, mapping agent 206 may identify that GPA is an indeterminate preference among all user profiles 222. By identifying those traits that the group of users prefers, mapping agent 206 may generate an ideal candidate description.

In some embodiments, matching agent 110 may further include segmentation agent 208. Segmentation agent 208 may be configured to segment (or partition) stock profiles 224 prior to displaying each stock profile to the group of users. For example, given a resume, segmentation agent 208 may segment predefined portions of the resume, such that a user can indicate which portions of the resume the user likes and which portions of the resume the user dislikes. By segmenting portions of stock profiles 228, information identifier 202 may be able to identify a particular user's preferences with a greater granularity.

Compatibility agent 210 may be configured to predict which candidate resumes 226 a particular user will prefer. Candidate profiles 226 may include one or more profiles received in response to the ideal candidate description. Compatibility agent 210 may compare each candidate resume 226 to one or more preferences 228 associated with each user account 228. Based on the comparison compatibility agent 210 may identify those candidate resumes 226 that a particular user is likely to prefer. In some embodiments, comparison compatibility agent 210 may further identify an order in which to display candidate resumes 226 to a particular user, based on a comparison score of each resume. For example, comparison compatibility agent 210 may place candidate resumes 226 in an order ranging from a highest scoring candidate profile to a lowest scoring candidate profile. Accordingly, a particular user may be presented with those candidate profiles 226 that the particular user is most likely to prefer first, prior to seeing further candidate profiles 226.

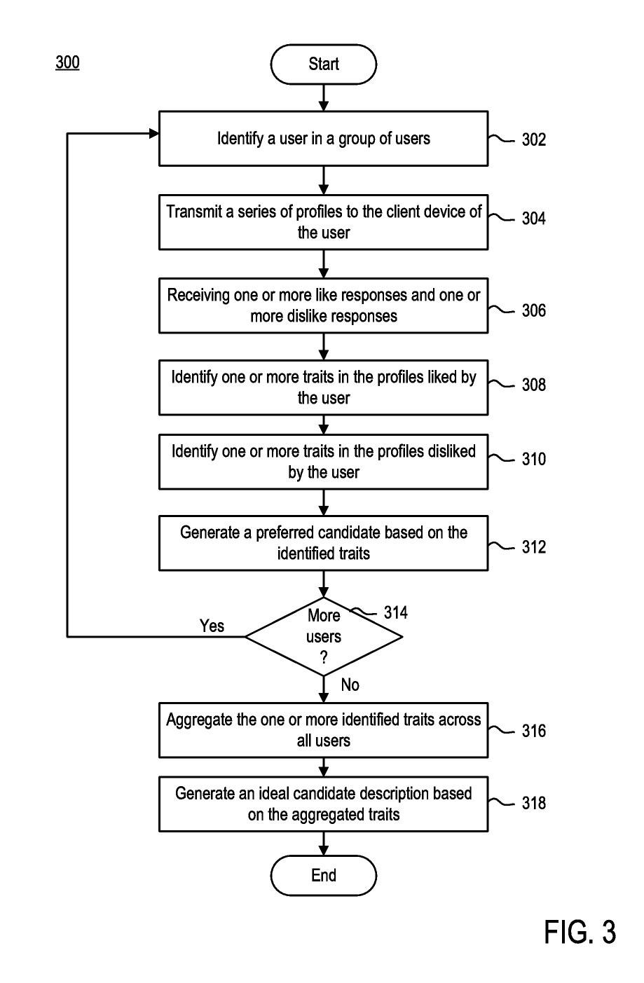

FIG. 3 is a flow diagram illustrating an exemplary method 300 of generating an ideal candidate description, according to one embodiment. Method 300 begins at step 302. At step 302, matching agent 110 may identify a user in a group of users. In particular, matching agent 110 may select a first user among a group of users for analysis. The group of users may include employees on a hiring committee of a place of business.

At step 304, matching agent 110 may transmit a series of profiles to client device 102 of the user for display. In particular, matching agent 110 may transmit a set of stock profiles (e.g., stock profiles 224) to client device 102 of user via application 108. Matching agent 110 may use the set of stock profiles to identify one or more preferences of the user for the ideal candidate description. Each stock profile may include one or more traits that may be pertinent to a position for which the ideal candidate description will be generated. For example, each stock profile may include education information, work experience information, and skills information pertinent to a particular description.

At step 306, matching agent 110 may receive one or more responses from client device 102 responsive to each displayed profile. For example, matching agent 110 may receive one or more like response and one or more dislike responses from client device 102 responsive to each displayed profile. In some embodiments, matching agent 110 may receive a like or dislike response responsive to a user providing touch input on client device 102. In one example, touch input on client device 102 may include a swipe input from a first portion of the client device 102 to a second portion of the client device (i.e., towards the right for a like, towards the left for a dislike). In one example, touch input on client device 102 may include a touch input on a first portion of the client device 102 corresponding to a like command or a second portion of the client device 102 corresponding to a dislike command.

At step 308, matching agent 110 may identify one or more traits in the one or more profiles liked by the user. In particular, information identifier 202 may identify one or more traits in each of the one or more stock profiles 224 liked by the user. In some embodiments, information identifier 202 may initially identify those one or more traits liked by the user across clusters of stock profiles 224. By analyzing clusters of stock profiles 224 initially, information identifier 202 may more accurately identify commonly liked traits among stock profiles 224. Subsequently, after establishing a baseline of user preferences, information identifier 202 may analyze stock profiles 224 on an individual basis.

At step 310, matching agent 110 may identify one or more traits in the one or more profiles disliked by the user. In particular, information identifier 202 may identify one or more traits in each of the one or more stock profiles 224 disliked by the user. In some embodiments, information identifier 202 may initially identify those one or more traits disliked by the user across clusters of stock profiles 224. By analyzing clusters of stock profiles 224 initially, information identifier 202 may more accurately identify commonly disliked traits among stock profiles 224. Subsequently, after establishing a baseline of user preferences, information identifier 202 may analyze stock profiles 224 on an individual basis.

At step 312, matching agent 110 may generate a preferred candidate based on the identified one or more preferences of the user. In particular, profile manager 204 may generate a preferred candidate on an individualized level for the user based on an aggregation of one or more traits in profiles liked and disliked by the user.

In some embodiments, profile manager 204 may further identify one or more biases associated with each user. In operation, profile manager 204 may analyze preferences associated with a particular user profile 222 to identify whether user associated with user account 222 is biased towards a particular trait. Profile manager 204 may adjust preferences 228 by applying one or more weights to each preference. Accordingly, upon generating a preferred candidate description particular to the user, profile manager 204 may take into account the one or more biases identified.

At step 314, matching agent 110 may determine whether there are any additional users in the group of users to analyze. If at step 314, matching agent determine there are additional users in the group of users that have yet to be analyzed, method 300 reverts to step 302. If, however, at step 314, matching agent 110 determines that all users in the group of user have been analyzed, then method 300 proceeds to step 316.

At step 316, matching agent 110 may aggregate the one or more preferences 228 of each user. In particular, mapping agent 206 may identify one or more traits among the one or more users that are commonly liked and commonly disliked.

At step 318, matching agent 110 may generate an ideal candidate description based on the aggregated preferences. In particular, matching agent 110 may generate an ideal candidate description based on those commonly liked and disliked traits among the one or more stock profiles 224.

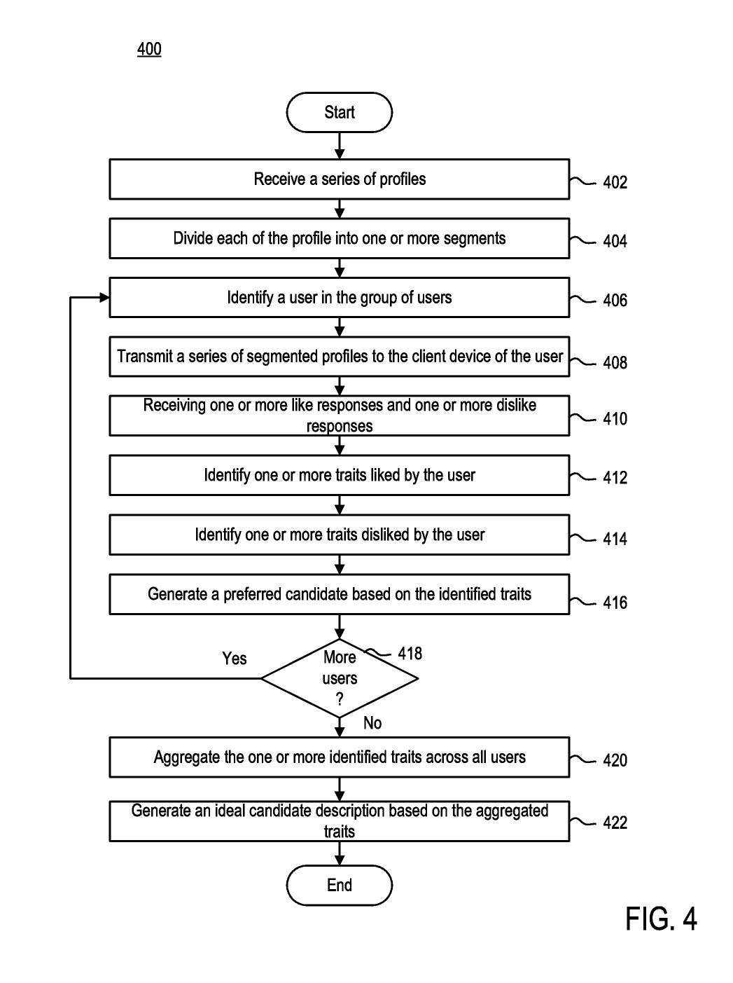

FIG. 4 is a flow diagram illustrating an exemplary method 400 of generating an ideal candidate description, according to one embodiment. Method 400 begins at step 402. At step 402, matching agent 110 may receive a series of profiles. In particular, matching agent 110 may receive a series of stock profiles 224. One or more profiles in stock profiles 224 may be displayed to a particular user in the process of generating an ideal description of a candidate. For example, stock profiles 224 may include one or more stock resumes submitted to the place of business. In another example, stock profiles 224 may include one or more stock resumes unrelated to the place of business. Matching agent 110 may present one or more stock profiles 224 to user to determine user's preferences of an ideal candidate for a particular job opening.

At step 404, matching agent 110 may partition each profile of the series of profiles into one or more segments. In particular, segmentation agent 208 may be configured to segment (or partition) stock profiles 224 prior to displaying each stock profile 224 to the group of users. For example, given a resume, segmentation agent 208 may segment predefined portions of the resume, such that a user can indicate which portions of the resume the user likes and which portions of the resume the user dislikes. By segmenting portions of stock profiles 224, information identifier 202 may be able to identify a particular user's preferences with a greater granularity.

At step 406, matching agent 110 may identify a user in a group of users. In particular, matching agent 110 may select a first user among a group of users for analysis. The group of users may include employees on a hiring committee of a place of business.

At step 408, matching agent 110 may transmit the series of profiles to client device 102 of the user for display. In particular, matching agent 110 may transmit the partitioned set of stock profiles 224 to client device 102 of user via application 108. Matching agent 110 may use the set of stock profiles to identify one or more preferences of the user for the ideal candidate description. Each stock profile may include one or more traits that may be pertinent to a position for which the ideal candidate description will be generated. For example, each stock profile may include education information, work experience information, and skills information pertinent to a particular description. In some embodiments, each of the one or more traits in each stock profile 224 may include its own actionable area. In some embodiments, each group of traits may include its own actionable area.

At step 410, matching agent 110 may receive one or more responses from client device 102 responsive to each displayed profile. For example, matching agent 110 may receive one or more like responses and one or more dislike responses from client device 102 responsive to each displayed profile. In some embodiments, matching agent 110 may receive a like or dislike response responsive to a user providing touch input on client device 102. In one example, touch input on client device 102 may include a swipe input from a first portion of the client device 102 to a second portion of the client device (i.e., towards the right for a like, towards the left for a dislike). In one example, touch input on client device 102 may include a touch input on a first portion of the client device 102 corresponding to a like command or a second portion of the client device 102 corresponding to a dislike command.

Because each stock profile 224 is segmented, a user may submit one or more dislike responses or one or more like responses for each stock profile 224. In some embodiments, a user may swipe right (e.g., like) on a first trait (e.g., GPA) in the stock profile 224 and swipe left (e.g., dislike) on a group of traits (e.g., work experience) in the stock profile 224.

At step 412, matching agent 110 may identify one or more traits in the one or more profiles liked by the user. In particular, information identifier 202 may identify one or more traits in each of the one or more stock profiles 224 liked by the user. In some embodiments, information identifier 202 may initially identify those one or more traits liked by the user across clusters of stock profiles 224. By analyzing clusters of stock profiles 224 initially, information identifier 202 may more accurately identify commonly liked traits among stock profiles 224. Subsequently, after establishing a baseline of user preferences, information identifier 202 may analyze stock profiles 224 on an individual basis.

At step 414, matching agent 110 may identify one or more traits in the one or more profiles disliked by the user. In particular, information identifier 202 may identify one or more traits in each of the one or more stock profiles 224 disliked by the user. In some embodiments, information identifier 202 may initially identify those one or more traits disliked by the user across clusters of stock profiles 224. By analyzing clusters of stock profiles 224 initially, information identifier 202 may more accurately identify commonly disliked traits among stock profiles 224. Subsequently, after establishing a baseline of user preferences, information identifier 202 may analyze stock profiles 224 on an individual basis.

At step 416, matching agent 110 may generate a preferred candidate based on the identified one or more preferences of the user. In particular, profile manager 204 may generate a preferred candidate on an individualized level for the user based on an aggregation of one or more traits in profiles liked and disliked by the user.

In some embodiments, profile manager 204 may further identify one or more biases associated with each user. In operation, profile manager 204 may analyze preferences associated with a particular user profile 222 to identify whether user associated with user account 222 is biased towards a particular trait. Profile manager 204 may adjust preferences 228 by applying one or more weights to each preference. Accordingly, upon generating a preferred candidate description particular to the user, profile manager 204 may take into account the one or more biases identified.

At step 418, matching agent 110 may determine whether there are any additional users in the group of users to analyze. If at step 418, matching agent determines there are additional users in the group of users that have yet to be analyzed, method 400 reverts to step 406. If, however, at step 418, matching agent 110 determines that all users in the group of user have been analyzed, then method 300 proceeds to step 420.

At step 420, matching agent 110 may aggregate the one or more preferences 228 of each user. In particular, mapping agent 206 may identify one or more traits among the one or more users that are commonly liked and commonly disliked.

At step 422, matching agent 110 may generate an ideal candidate description based on the aggregated preferences. In particular, matching agent 110 may generate an ideal candidate description based on those commonly liked and disliked traits among the one or more stock profiles 224.

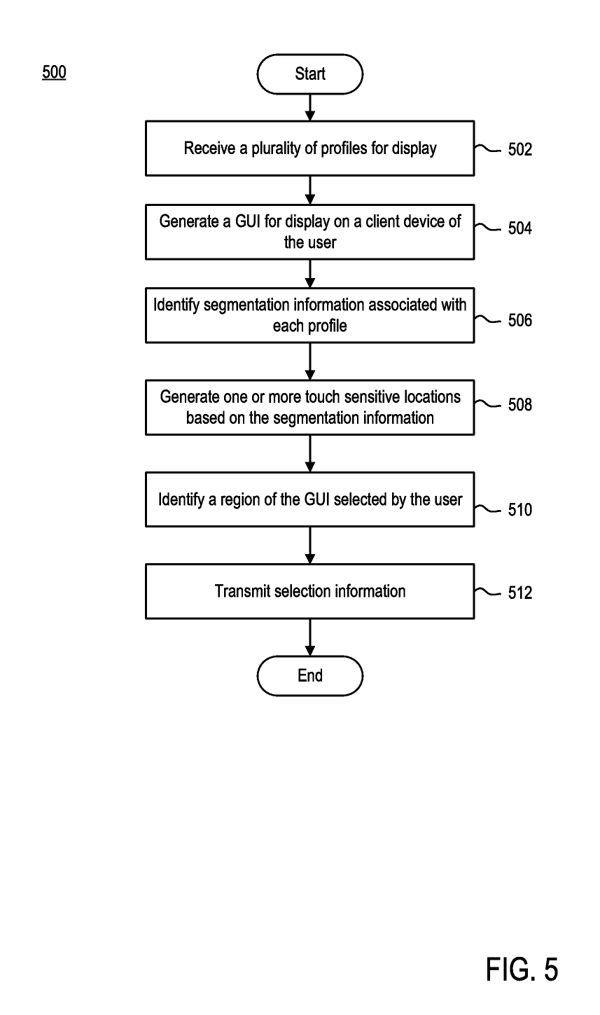

FIG. 5 is a flow diagram illustrating an exemplary method 500 of identifying a selection of a user, according to one embodiment. Method 500 begins at step 502. At step 502, client device 102 may receive a stock profile 228 for display to user.

At step 504, client device 102 may generate a graphical user interface (GUI) for display on client device 102. In particular, client device 102 may generate a GUI that includes the received stock profile 228.

At step 506, client device 102 may identify segmentation information associated with stock profile. In particular, client device may parse a request received from matching agent 110 to identify segmentation information contained therein. Segmentation information may include information directed to predefined portions of the resume that allow a user to indicate which particular portions of the resume the user likes and which particular portions of the resume the user dislikes. By segmenting portions of stock profiles 224, the back-end system (i.e., matching agent 110) may be able to identify a particular user's preferences with a greater granularity.

At step 508, client device 102 may generate one or more touch sensitive locations on the GUI based on the segmentation information. In particular, client device 102 may convert portions of stock profile 228 into one or more actionable portions of the GUI. In operation, a user may swipe the one or more actionable portions of the GUI to indicate whether the user likes or dislikes the one or more traits contained in the one or more actionable portions.

At step 510, client device 102 may identify a region of the GUI selected by the user. In particular, client device 102 may identify a region of the GUI that has registered a touch input. In some embodiments, the touch input is a touch input on an actionable button (e.g., thumbs-up button, thumbs-down button). In some embodiments, the touch input is a swipe input in a particular direction (e.g., swipe right, swipe left).

At step 512, client device 102 may transmit the selection information to matching agent 110. For example, client device 102 may identify the actionable item selected by the user, as well as the type of input received for the actionable item, and submit the selection information to matching agent 110.

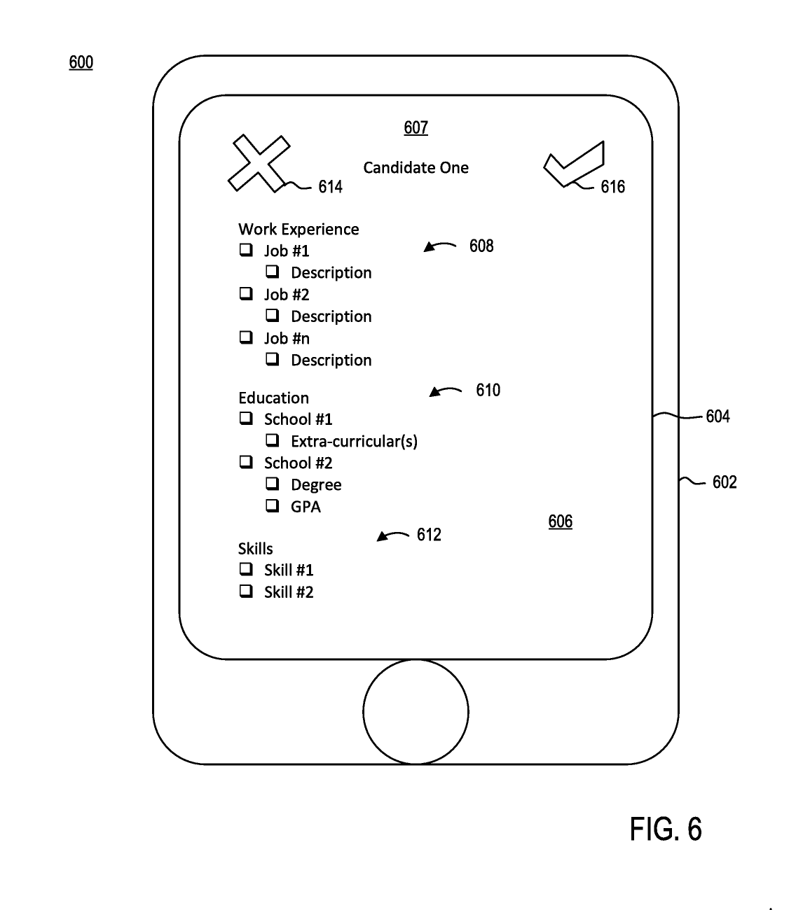

FIG. 6 is a block diagram 600 illustrating an exemplary graphical user interface (GUI) 606 displayed on a client device, according to one embodiment. Block diagram 600 includes a client device 602. Client device 602 may include a screen 604. GUI 606 is displayed on screen 604 of client device 602. Displayed on GUI 606 is a profile 607 for Candidate One. Profile 607 includes one or more traits or skills of Candidate One. In some examples, one or more traits of a candidate may include educational background, GPA, geographical location, and the like. In some examples, one or more skills of a candidate may include work experience and practical skills (e.g., programming languages, foreign languages, professional licenses, etc.).

Upon reviewing profile 607, user may provide an indication as to whether the user liked or disliked profile 607. In some embodiments, user may provide the indication via a swipe gesture. The swipe gesture is a touch input in which the user performs an initial touch input and drags his or her finger across the screen in a predefined direction. The direction of the swipe gesture may provide the indication of whether the user liked or disliked profile 607. In some embodiments, a swipe gesture towards a left-hand side of screen 604 is indicative of the user disliking profile 607. In some embodiments, a swipe gesture towards a right-hand side of screen 604 is indicative of the user liking profile 607.

In some embodiments, user may provide the indication via one or more predefined buttons displayed to user on GUI 606. As illustrated, GUI 606 includes dislike button 614 (illustrated as an “X”) and like button 616 (illustrated as a check mark). User may provide the indication via a touch input on one of dislike button 614 and like button 616.

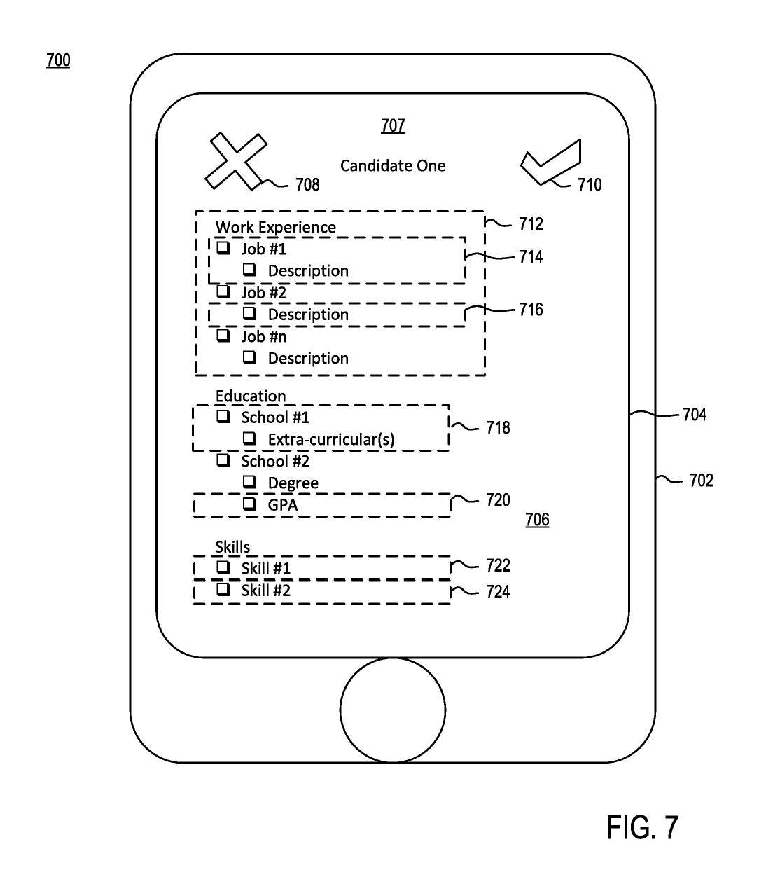

FIG. 7 is a block diagram 700 illustrating an exemplary GUI displayed on a client device, according to one embodiment. Block diagram 700 includes a client device 702. Client device 702 may include a screen 704. GUI 706 is displayed on screen 704 of client device 702. Displayed on GUI 706 is a profile 707 for Candidate One. Profile 707 includes one or more traits or skills of Candidate One. In some examples, one or more traits of a candidate may include educational background, GPA, geographical location, and the like. In some examples, one or more skills of a candidate may include work experience and practical skills (e.g., programming languages, foreign languages, professional licenses, etc.).

As illustrated, profile 707 may include one or more actionable portions generated by client device 702 based on segmentation information received from matching agent 110. In particular, profile 707 may include actionable portions 712-724. Each actionable portion 712-724 may correspond to at least one trait or skill of Candidate One. As illustrated, actionable portion 712 corresponds to work experience skills; actionable portion 714 corresponds to a specific work experience skill (i.e. Job #1). Actionable portion 716 corresponds to a particular skill (i.e. description of Job #2). Actionable portion 718 corresponds to a particular trait (e.g., School #1). Actionable portion 720 corresponds to a particular trait (e.g., GPA of School #2). Actionable portion 722 corresponds to a particular skill (e.g., Skill #1). Actionable portion 724 corresponds to a particular skill (e.g., Skill #2).

Upon reviewing profile 707, user may provide an indication as to whether the user liked or disliked one or more actionable portions 712-724 profile 707. In some embodiments, user may provide the indication via a swipe gesture on the one or more actionable portions 712-714. Accordingly, one or more actionable portions 712-724 of profile 707 allows a user to like some traits and/or skills of the user while disliking other traits and/or skills of the user.

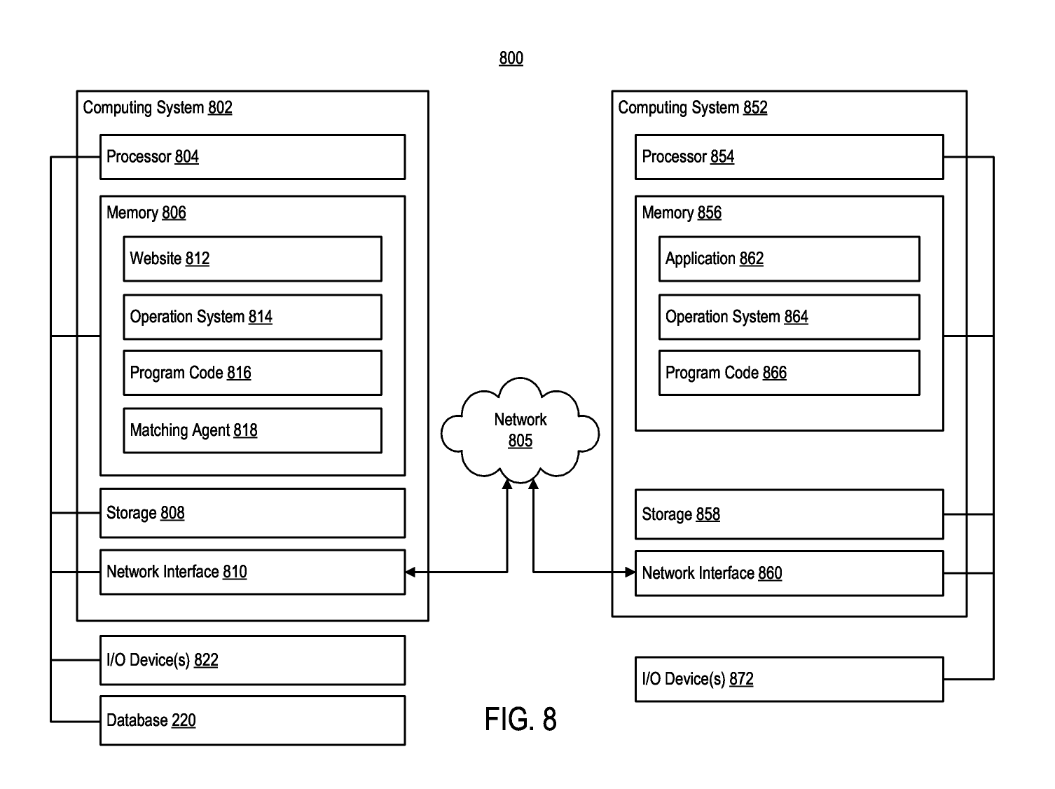

FIG. 8 is a block diagram illustrating an exemplary computing environment 800, according to one embodiment. Computing environment 800 includes computing system 802 and computing system 852. Computing system 802 may be representative of management entity 104. Computing system 852 may be representative of client device 102.

Computing system 802 may include a processor 804, a memory 806, a storage 808, and a network interface 810. In some embodiments, computing system 802 may be coupled to one or more I/O device(s) 822. In some embodiments, computing system 802 may be in communication with database 210.

Processor 804 retrieves and executes program code 816 (i.e., programming instructions) stored in memory 806, as well as stores and retrieves application data. Processor 804 is included to be representative of a single processor, multiple processors, a single processor having multiple processing cores, and the like. Network interface 810 may be any type of network communications enabling computing system 802 to communicate externally via computing network 805. For example, network interface 810 allows computing system 802 to communicate with computer system 852.

Storage 808 may be, for example, a disk storage device. Although shown as a single unit, storage 808 may be a combination of fixed and/or removable storage devices, such as fixed disk drives, removable memory cards, optical storage, network attached storage (NAS), storage area network (SAN), and the like.

Memory 806 may include website 812, operating system 814, program code 816, and matching agent 818. Program code 816 may be accessed by processor 804 for processing (i.e., executing program instructions). Program code 816 may include, for example, executable instructions configured to perform steps discussed above in conjunction with FIGS. 3-4. As an example, processor 804 may access program code 816 to perform operations for generating an ideal candidate description via a web browser/application (e.g., application 862). In another example, processor 804 may access program code 816 to perform operations for generating one or more sets of synthetic identification information. Website 812 may be accessed by computing system 852. For example, website 812 may include content accessed by computing system 852 via a web browser or application.

Matching agent 818 may be configured to generate an ideal description of a candidate. In operation, application 862 executing on computing system 852 may present to user a plurality of profiles to be displayed to the user. For example, application 862 may present to user a plurality of job resumes for a job opening at user's place of employment. Via application 862, user of computing system 852 may either like or dislike each profile. Matching agent 818 may aggregate likes or dislikes from a plurality of users (e.g., a plurality of employees at the place of employment) to generate an ideal candidate description. For example, matching agent 818 may identify common traits among those profiles that are liked and disliked, and subsequently generate requirements for the job based on these identified traits.

Computing system 852 may include a processor 854, a memory 856, a storage 858, and a network interface 860. In some embodiments, computing system 852 may be coupled to one or more I/O device(s) 872 (e.g., keyboard, mouse, etc.).

Processor 854 retrieves and executes program code 866 (i.e., programming instructions) stored in memory 856, as well as stores and retrieves application data. Processor 854 is included to be representative of a single processor, multiple processors, a single processor having multiple processing cores, and the like. Network interface 860 may be any type of network communications allowing computing system 852 to communicate externally via computing network 805. For example, network interface 860 is configured to enable external communication with computing system 802.

Storage 858 may be, for example, a disk storage device. Although shown as a single unit, storage 858 may be a combination of fixed and/or removable storage devices, such as fixed disk drives, removable memory cards, optical storage, network attached storage (NAS), storage area network (SAN), and the like.

Memory 856 may include application 862, operating system 864, and program code 866. Program code 866 may be accessed by processor 854 for processing (i.e., executing program instructions). Program code 866 may include, for example, executable instructions for communicating with computing system 802 to display one or more pages of website 812. Application 862 may enable a user of computing system 852 to access a functionality of computing system 802. For example, application 862 may access content managed by computing system 802, such as website 812. The content that is displayed to a user of computing system 852 may be transmitted from computing system 802 to computing system 852, and subsequently processed by application 862 for display through a graphical user interface (GUI) of computing system 852. In another example, application 862 may access functionality managed by computing system 802, such as the functionality of matching agent 818.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method, comprising:
identifying, by a computing system, a group of users, wherein the group comprises at least a first user;
for each user of the group of users, generating, by the computing system, one or more graphical user interfaces (GUIs) comprising a series of stock profiles, each stock profile comprising a job resume, the one or more GUIs seeking user input to identify user preferences of an ideal candidate for a job opening;
transmitting, by the computing system, the one or more GUIs to each respective user of the group of users to prompt each user to provide feedback for each stock profile displayed to the user;
receiving, by the computing system via the one or more GUIs, a first set of user inputs corresponding to one or more stock profiles of the series of stock profiles that are disliked by one or more users of the group of users;
receiving, by the computing system, via the one or more GUIs, a second set of user inputs corresponding to one or more stock profiles of the series of stock profiles that are liked by one or more users of the group of users;
for each stock profile that is disliked, identifying, by the computing system, one or more traits of the candidate represented by the stock profile;
for each stock profile that is liked, identifying, by the computing system, one or more traits of the candidate represented by the stock profile;
generating, by the computing system, a preferred candidate profile for each user based on the identified one or more traits that have been liked and the one or more traits that have been disliked;
aggregating, by the computing system, the one or more traits liked by all users of the group of users and the one or more traits disliked by all users of the group of users;
generating an ideal candidate description based on the aggregated one or more traits;
receiving, by the computing system, a plurality of candidate profiles for the job opening represented by the ideal candidate description;
for each user of the group of users, predicting a subset of candidate profiles the user will prefer based on the preferred candidate profile of the user and the ideal candidate description;
generating, by the computing system, one or more further GUIs for each user, the one or more further GUIs comprising a customized ordering of candidate profiles based on the predicting; and
transmitting, by the computing system, the one or more further GUIs to each respective client device of the one or more users.

2. The method of claim 1, wherein predicting a subset of candidate profiles that the user will prefer based on stock profiles comprises:
comparing, by the computing system, each of the plurality of candidate profiles to the ideal candidate description.

3. The method of claim 2, further comprising:
scoring, by the computing system, each of the plurality of candidate profiles based on the ideal candidate description.

4. The method of claim 3, wherein transmitting, by the computing system, the one or more further GUIs to each respective client device of the one or more users, comprises:
transmitting the one or more further GUIs to each respective client device of the one or more users, in an order ranging from a highest scoring candidate profile to a lowest scoring candidate profile for each user.

5. The method of claim 2, further comprising:
scoring, by the computing system, each of the plurality of candidate profiles based on the preferred candidate profile of each user.

6. The method of claim 5, further comprising:
transmitting, by the computing system, each of the one or more further GUIs, each further GUI comprising a candidate profile of the plurality of candidate profiles to the first client device of the first user in an order ranging from a highest scoring candidate profile to a lowest scoring candidate profile, based on a first preferred candidate profile associated with the first user.

7. The method of claim 1, wherein generating, by the computing system, the preferred candidate profile for each user based on the identified one or more elements that have been liked and the one or more elements that have been disliked, comprising:
analyzing each profile liked and disliked by the first user;
identifying a pattern of behavior of profile liking that is indicative of a bias; and
adjusting the preferred candidate profile for the first user based on the bias.

8. The method of claim 1, wherein identifying, by the computing system, the one or more traits of the candidate represented by the profile, comprises:
scanning the profile; and
extracting the one or more traits from the profile.

9. A method, comprising:
identifying, by a computing system, a group of users, wherein the group comprises at least a first user;
receiving, by the computing system, a series of profiles, each profile in the series of profiles comprising a job resume representing a stock candidate;
dividing, by the computing system, each of the profiles into one or more segments, wherein each segment corresponds to a particular trait of the candidate represented by the profile;
generating, by the computing system, one or more graphical user interfaces (GUIs) comprising the series of profiles and one or more selectable regions, each selectable region corresponding to a segment of the one or more segments of each profile, the one or more GUIs seeking user input to identify user preferences of an ideal candidate for a job opening;
for each user of the group of users, transmitting, by the computing system, the one or more GUIs to each respective user of the group of users for display on a respective client device of each user to prompt the user to provide feedback for each profile displayed to the user;
receiving, by the computing system via the one or more GUIs, a first set of user inputs corresponding to one or more profiles of the series of profiles that are disliked by one or more users of the group of users;
receiving, by the computing system, via the one or more GUIs, a second set of user inputs corresponding to one or more profiles of the series of profiles that are liked by one or more users of the group of users;
identifying, by the computing system, one or more traits liked by each user across the series of profiles;
identifying, by the computing system, one or more traits disliked by each user across the series of profiles;
generating, by the computing system, a preferred candidate profile for each user based on the identified one or more traits that have been liked and the one or more traits that have been disliked;
aggregating, by the computing system, the one or more traits liked by the users and the one or more traits disliked by the users;
generating, by the computing system, an ideal candidate description based on the aggregated one or more traits;
receiving, by the computing system, a plurality of candidate profiles for the job opening represented by the ideal candidate description;
for each user of the group of users, predicting a subset of candidate profiles the user will prefer based on stock profiles liked by the user and disliked by the user and the ideal candidate description;
generating, by the computing system, one or more further GUIs for each user, the one or more further GUIs comprising a customized ordering of candidate profiles based on the predicting; and
transmitting, by the computing system, the one or more further GUIs to each respective client device of the one or more users.

10. The method of claim 9, wherein predicting a subset of candidate profiles that the user will prefer based on stock profiles comprises:
comparing, by the computing system, each of the plurality of candidate profiles to the ideal candidate description.

11. The method of claim 10, further comprising:
scoring, by the computing system, each of the plurality of candidate profiles based on the ideal candidate description.

12. The method of claim 11, wherein transmitting, by the computing system, the one or more further GUIs to each respective client device of the one or more users, comprises:
transmitting the one or more further GUIs to each respective client device of the one or more users, in an order ranging from a highest scoring candidate profile to a lowest scoring candidate profile for each user.

13. The method of claim 10, further comprising:
scoring, by the computing system, each of the plurality of candidate profiles based on the preferred candidate profile of each user.

14. The method of claim 13, further comprising:
transmitting, by the computing system, each of the plurality of candidate profiles to the first client device of the first user in an order ranging from a highest scoring candidate profile to a lowest scoring candidate profile, based on a first preferred candidate profile associated with the first user.

15. The method of claim 9, wherein generating, by the computing system, the preferred candidate profile for each user based on the identified one or more elements that have been liked and the one or more elements that have been disliked, comprising:
analyzing each profile liked and disliked by the first user;
identifying a pattern of behavior of profile liking that is indicative of a bias; and
adjusting the preferred candidate profile for the first user based on the bias.

16. The method of claim 9, wherein identifying, by the computing system, one or more traits of the candidate represented by the profile, comprises:
scanning the profile; and
extracting the one or more traits from the profile.

17-20. (canceled)

21. A method, comprising:
receiving, by a client device of a group of client devices from a computing system, one or more graphical user interfaces (GUIs) comprising a series of stock profiles, each stock profile in the series of profiles comprises a job resume, the one or more GUIs seeking user input to identify user preferences of an ideal candidate for a job opening;
rendering, by the client device, the one or more graphical user interfaces (GUIs) for display on the client device, for each of the series of profiles;
identifying, by the client device, segmentation information, received from the computing system, associated with each of the series of profiles, wherein each segmentation information comprises boundary information for one or more portions of each profile, wherein each of the one or more portions corresponds to a trait in the profile;
rendering, by the client device, one or more touch sensitive locations in the GUI, based on the segmentation information;
receiving, by the client device, a first set of inputs, via the one or more GUIs, corresponding to one or more stock profiles that are disliked by the user by identifying a first portion of one or more GUIs selected by the user;
receiving, by the client device, a second set of inputs, via the one or more GUIs, corresponding to one or more stock profiles that are disliked by the user by identifying a second portion of one or more GUIs selected by the user;
transmitting, by the client device, the first set of inputs and the second set of inputs to the computing system to generate an ideal candidate description and a preferred candidate profile based on the first set of inputs and the second set of inputs, wherein the ideal candidate description is based on aggregated traits liked by all users of the group of client devices and disliked by all the users of the group of client devices;
receiving, by the client device from the computing system, one or more further GUIs comprising a customized ordering of candidate profiles based on a comparison of the ideal candidate description and the preferred candidate profile to a set of the candidate profiles; and
transmitting, by the client device, a third set of inputs corresponding to candidate profiles liked by the user.

22. The method of claim 21, wherein each of the one or more GUIs comprises a dislike button and a like button.

23. The method of claim 21, wherein receiving, by the client device, the second set of inputs, via the one or more GUIs, comprises:
receiving a dragging input of a finger across the first portion of each GUI.

24. The method of claim 21, wherein receiving, by the client device, the second set of inputs, via the one or more GUIs, comprises:
identifying at least two regions of each GUI selected by the user.
